(19) United States
(12) Patent Application Publication
(10) Pub. No.: US 2012/0255815 A1
(43) Pub. Date: Oct. 11, 2012

(54) EMERGENCY EXIT DOOR OF AN ELEVATOR CAR

(75) Inventor: Kalevi Koskelainen, Hyvinkaa (FI)

(73) Assignee: KONE CORPORATION, Helsinki (FI)

(21) Appl. No.: 13/474,845

(22) Filed: May 18, 2012

Related U.S. Application Data
(63) Continuation of application No. PCT/FI2010/050934, filed on Nov. 18, 2010.

(30) Foreign Application Priority Data
Nov. 18, 2009 (FI) 20090438

(51) Int. Cl. B66B 11/02

(52) U.S. Cl. 187/401

(57) ABSTRACT

The object of the invention is an emergency exit door of an elevator car, in which elevator car the emergency exit door is hinged to at least one wall of the elevator car. The emergency exit door is hinged to a wall of the elevator car to turn around two essentially vertical hinge lines.

This application is a continuation of international application PCT/FI2010/050934 filed on Nov. 18, 2010 and claims priority under 35 U.S.C. §120 to FI 20090438 filed on Nov. 18, 2009, the entire contents of each of which are hereby incorporated herein by reference.

The object of the invention is an emergency exit door of an elevator car as defined in the preamble of claim 1.

Known in the art is, among other things, an emergency exit door disposed on a side wall of an elevator car, which emergency exit door is hinged at its top edge and at its bottom edge with pin hinges in the side wall structures of the elevator car. For practical reasons the hinge cannot be disposed exactly on the second edge of the emergency exit door, in which case when turning the door around its hinge line inwards into the elevator car the edge of the door on the other side of the hinge line turns to outside the elevator car. This type of function is not always possible owing to lack of space, e.g. in double-decker elevator cars. Another problem is that a door hinged in this way detracts from the interior decoration of the elevator. An interior'decoration panel that is only the width of the door, for example, must always be situated at the point of the door, which interior decoration panel is generally narrower than the other interior decoration panels.

An emergency exit solution is also known from Japanese patent publication no. JP2018275(A), which solution comprises a separate hatch that can be lifted to inside the elevator car, which hatch in normal drive of the elevator is fixed to a side wall of the elevator car. A problem with this solution also is that the hatch disturbs the interior decoration of the elevator. Owing to weight considerations, the hatch cannot be the full height of the wall, in which case the top edge of the hatch bisects the interior decoration panel in the height direction. Additionally, the hatch must comprise lifting handles of large size that are strong enough, for moving the hatch. The lifting handles are also visible in the interior decoration, disturbing the general appearance of the interior decoration.

The aim of this invention is to eliminate the aforementioned drawbacks and to achieve a simple and inexpensive emergency exit door of an elevator car, which can be easily fitted as a part of the interior decoration of an elevator car. In addition, an aim is to achieve an emergency exit door that conforms to regulations and that does not cross the exterior line of the outer walls of the elevator car when opening the door. The emergency exit door according to the invention is characterized by what is presented in the characterization part of claim 1. Other embodiments of the invention are characterized by what is disclosed in the other claims.

Some inventive embodiments are also discussed in the descriptive section of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. Likewise the different details presented in connection with each embodiment can also be applied in other embodiments. In addition it can be stated that at least some of the subordinate claims can at least in some situations be deemed to be inventive in their own right.

One advantage of the emergency exit door solution according to the invention is that by means of it the interior decoration solutions of an elevator car can be made more freely than before. In this case it is possible e.g. to use normal-sized interior decoration panels also at the point of the emergency exit door. The emergency exit door itself can be narrower and shallower than the interior decoration panel fixed to the inner surface of the door, which interior decoration panel is able to turn along with the emergency exit door to inside the elevator car when opening the emergency exit door. Another advantage is that the emergency exit door can be manufactured to be of standard size. A door of the same size and shape is suited to all cars and the interior decoration panels are selected according to the other interior decoration. In this case also elevator-specific design is omitted, so the design work is speeded up and facilitated. Likewise the installation work is speeded up and facilitated, and errors do not occur in the installation as easily as before. Another advantage is that the emergency exit door according to the invention is also suited to small elevator cars. A further advantage is that complex and expensive adjustment lever systems can be omitted, in which case the solution according to the invention is simple and inexpensive to implement.

In the following the invention will be described in more detail by the aid of one example of its embodiment with reference to the attached drawings, wherein

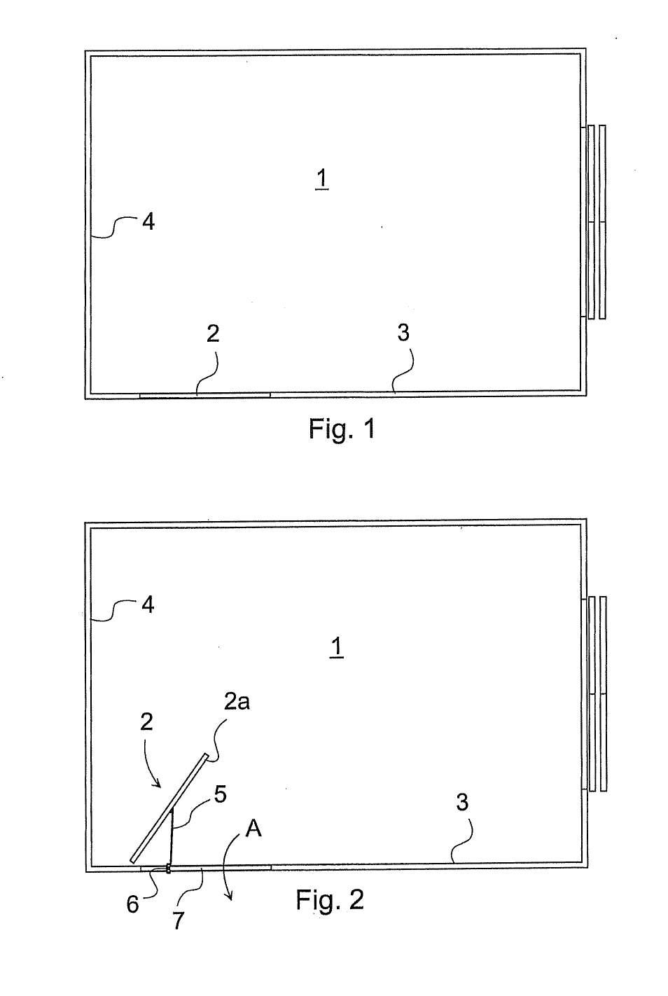

FIG. 1 presents a simplified top view of an elevator car, in which the emergency exit door according to the invention is closed,

FIG. 2 presents a simplified top view of an elevator car, in which the emergency exit door according to the invention is open,

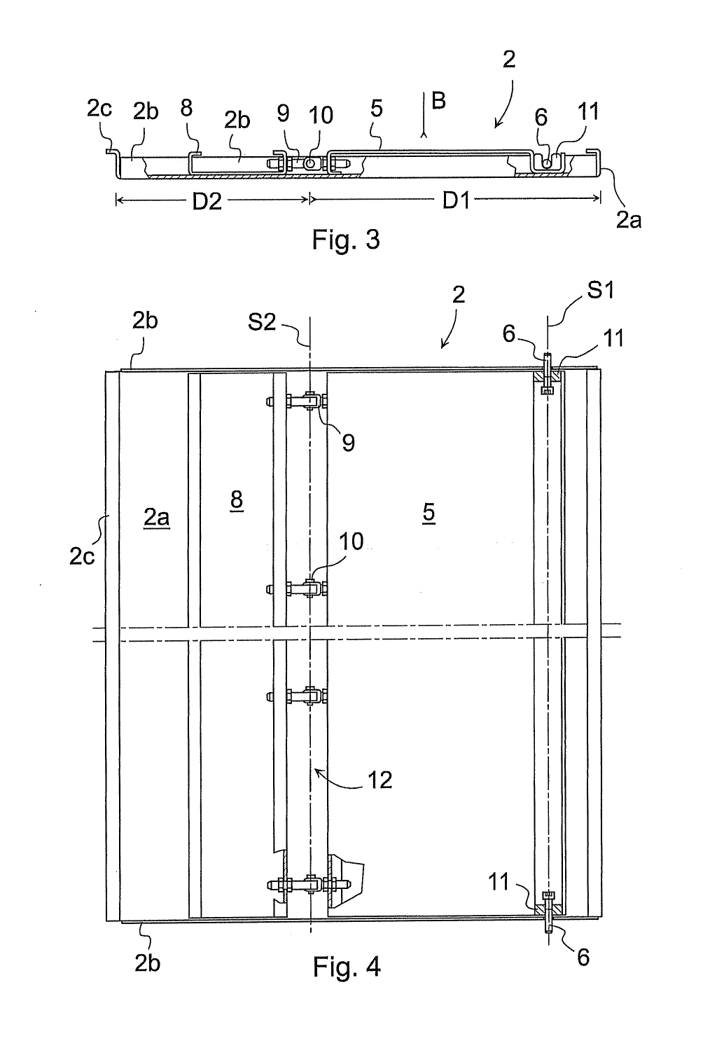

FIG. 3 presents a partially sectioned top view of an emergency exit door according to the invention,

FIG. 4 presents a cut and partially sectioned emergency exit door according to the invention, as viewed from the outside, i.e. as viewed from the direction B of FIG. 3,

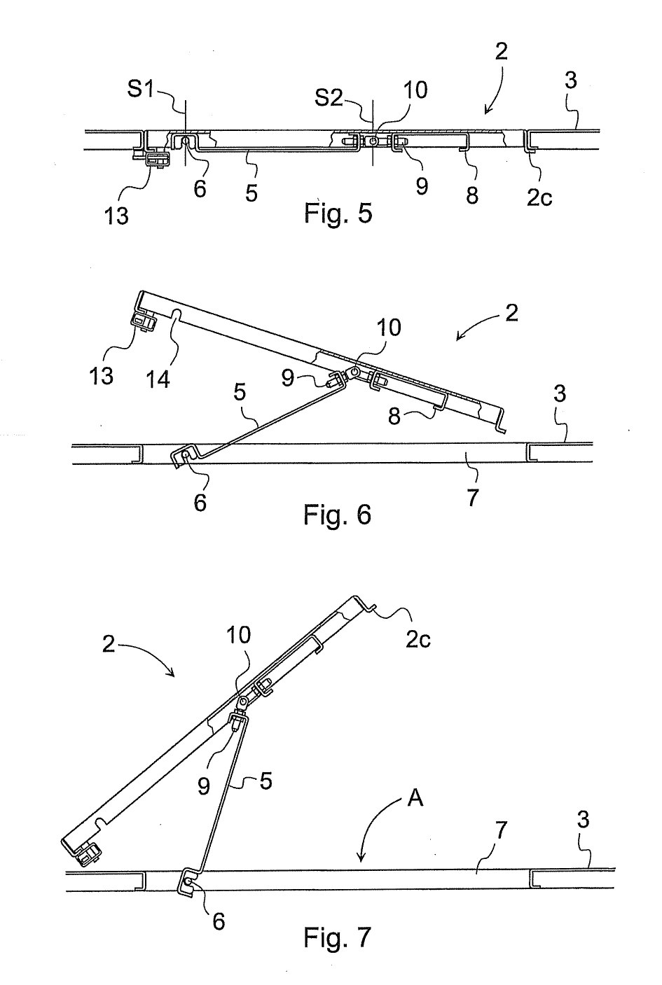

FIG. 5 presents a partially sectioned top view of an emergency exit door according to the invention in the closed position,

FIG. 6 presents a partially sectioned top view of an emergency exit door according to the invention in the opening phase, and

FIG. 7 presents a partially sectioned top view of an emergency exit door according to the invention in the open position.

FIGS. 1 and 2 present a top view of an elevator car 1, which comprises at least side walls 3 and a rear wall 4. One side wall 3 comprises an emergency exit door 2, which is sunk into the wall structure of the side wall 3 such that the inner surface of the emergency exit door 2 when it is closed is on essentially the same vertical plane as the inner surface of the side wall 3 of the elevator car. If the inner surface of the side wall 3 of the elevator car 1 is e.g. of stainless steel, the inner surface of the emergency exit door 2 also can be of similar stainless steel. If the inside walls of the elevator car 1 are covered with some interior decoration panel, the same type of interior decoration panel can also be fixed to the inside surface of the emergency exit door 2, in which case all of the interior decoration is uniform. In addition, the interior decoration panel fixed to the emergency exit door 2 can be higher and wider than the door and can extend to the side of the emergency exit door 2. Thus on top of the emergency exit door 2 can be e.g. a whole interior decoration panel, which is as large as also the other interior decoration panels of the elevator car. In the case according to the embodiment the emergency exit door 2 is closer to the rear wall of the elevator car 1 than to the front wall.

In FIG. 1 the emergency exit door 2 is closed and in FIG. 2 opened, in which case the door panel 2a has been turned into an inclined position around two vertical hinge lines S1 and S2. The hinge lines S1 and S2 are presented in more detail in FIGS. 4 and 5. The emergency exit door 2 comprises a support means 5 that is essentially the height of the door panel 2a, which support means is hinged at its first end to the structures of a side wall 3 of the elevator car 1 with pin-type hinges 6 and at its second end to the door panel 2a. When the emergency exit door 2 is opened, the side wall 3 of the elevator car 1 contains an opening 7 that functions as an emergency exit, via which passengers are able to exit the elevator car 1 in the direction shown by the arrow A.

In FIGS. 3 and 4 the emergency exit door 2 according to the invention is presented in more detail, disconnected and for the sake of clarity partially sectioned. In FIG. 3 the emergency exit door 2 is presented such that the interior of the door is at the bottom in the figure. Correspondingly, in FIG. 4 the emergency exit door 2 is presented as viewed from the outside, i.e. as viewed from the direction B of FIG. 3. The emergency exit door 2 comprises a door panel 2a at least essentially the width of the whole door 2, which door panel is bent from steel plate such that the end edges 2b and the side edges of the door panel 2a are bent approx. 90° inwards. Both side edges also comprise a second approx. 90° bend, which on the first side edge is towards the center line of the emergency exit door 2 and on the second side edge outwards from the door forming a detent 2c that rests on the wall of the elevator car 1.

A channel-type fixing element 8 of C-shaped cross-sectional profile with a straight back is fixed at its rear to the outside of the door panel 2a, to an even surface of the door panel 2a, the thickness of the cross-section of which fixing element is essentially the same as the thickness of the cross-section of the door panel 2a. The fixing element 8 extends essentially from the bottom edge of the door to the top edge of the door such that a small gap remains between the ends of the fixing element 8 and the bendings 2b of the ends of the door panel 2a. In addition, a support means 5 is hinged to the outside of the door panel 2 by means of screw-type hinges 6 such that one hinge 6 is on the top edge of the door and the other hinge 6 is on the bottom edge of the door. The hinges 6 on the top edge and on the bottom edge between them form a first straight hinge line S1. The hinges 6 are disposed in support pieces 11 that are fixed to a recess in the support means 5. The support pieces 11 contain a hole provided with a screw thread, into which hole screws that function as a hinge 6 are screwed when installing the emergency exit door 2. The wall structure of the side wall 3 of the elevator car 1 comprises support pieces that correspond to the support pieces 11 that are on the top and on the bottom of the door opening 7, into the screw threads in which screws that function as a hinge 6 are further screwed when installing the emergency exit door 2. Thus the height position of the emergency exit door 2 can be adjusted by means of the hinge screws 6.

The support means 5 is a channel-type structure, the thickness of the cross-section of which is essentially the same as the thickness of the cross-section of the door panel 2a. Like the fixing element 8, also the support element 5 extends essentially from the bottom edge to the top edge of the door such that a small gap remains between the ends of the fixing element 5 and the bendings 2b of the ends of the door panel 2a. The support element 5 comprises two channel-type parts in its cross-section, of which the narrower part that is on the first edge of the support element 5 opens outwards from the door and contains the aforementioned support pieces 11, and the wider part on the second edge opens in the opposite direction, i.e. in the direction of the door panel 2a in the finished door structure.

The second edge of the support element 5 is at a horizontal distance from the first edge of the fixing element 8, in which case a vertical gap 12 of the door remains between the edges, which gap enables space for a plurality of hinges 9, which are disposed between the fixing element 8 and the support element 5 at a vertical distance from each other. The hinges 10 are fixed at their first end to the second edge of the support element 5 with a bolt-nut fixing, and at their second end to the first edge of the fixing element also with a bolt-nut fixing, which fixing enables horizontal adjustment of the hinges 9. The halves of the hinges 9 are joined together with hinge pins 10, the vertical line of which forms a second hinge line S2.

In order for the emergency exit door 2 to close well and to be easy to open, the ratio of the position of the hinges 9 and of the width of the door panel 2a must be suitable. In FIG. 3 the distance from the first edge of the door panel 2a to the center line of the hinge pins 10 is marked with the reference D1. Correspondingly, the distance from the second edge of the door panel 2a to the center line of the hinge pins 10 is marked with the reference D2. In the case according to the figure the ratio of the distance D1 to the distance D2 is approx. 3/2, i.e. approx. 1.5. The ratio can be of another magnitude also and can differ e.g. such that it is roughly between 1.2 . . . 1.8. Preferably, however, the ratio is e.g. roughly between 1.4 . . . 1.6.

FIGS. 5-7 present a top view of the operation of an emergency exit door 2 according to the invention. In FIG. 5 the emergency exit door 2 is closed and is in this case locked, by means of a lock 13 operated from inside the elevator car, into its opening 7 in the side wall 3 of the elevator car. In this case the lock 13 on the first edge of the emergency exit door 2 and the detent 2c on the second edge of the emergency exit door 2 prevent the emergency exit door 2 from opening by itself inward into the elevator car. Correspondingly, the top edge and the bottom edge of the emergency exit door 2 rest from inside on the detents on the top edge and on the bottom edge of the opening 7 such that the emergency exit door 2 is not able to open outwards. The detents on the top edge and on the bottom edge of the opening 7 are not shown in the figures.

In FIG. 6 the emergency exit door 2 is at the start of its opening phase. The lock 13 is turned into its open position and the edge of the emergency exit door 2 on the lock 13 side is pulled towards the inside part of the elevator car. In this case the emergency exit door 2 starts to retract and to simultaneously turn around both its hinge lines S1 and S2, and to lift away from the opening 7 such that the detent 2c is able without obstruction to pass the side edge of the opening 7. When the emergency exit door 2 opens the support means 5 turns around the hinge pins 6 on the stationary hinge line S1 and the emergency exit door 2 turns in relation to the support means 5 around the hinge pins 10 of the hinges 9 on a moving hinge line S2. In FIG. 6 a groove 14 in the end edges 2b of the door panel 2 of the emergency exit door 2 is also visible, which groove enables the placement of the emergency exit door 2 in the opening 7 by directing it onto the hinge pin 6 when closing the emergency exit door 2.

In FIG. 7 the emergency exit door 2 is in its open position, in which case between the second edge of the emergency exit door 2 and the second edge of the opening 7 is such a large gap that people can exit from the elevator car in the direction of the arrow A. From FIG. 7 it is seen that the support means 5 has turned counterclockwise around the hinge pins 6, whereas the emergency exit door 2 has simultaneously turned clockwise around the hinge pins 10. In this way, therefore, the support means 5 and the emergency exit door 2 are fitted to turn around their hinges during the same simultaneous movement in opposite directions to each other.

It is obvious to the person skilled in the art that the invention is not limited solely to the example described above, but that it may be varied within the scope of the claims presented below. Thus, for example, the structure of the emergency exit door and hinging can differ to what is presented above.

It is also obvious to the person skilled in the art that the emergency exit door can be disposed in a different point of the elevator car than what is presented above. The emergency exit door can also be on the rear wall of the elevator car or on a side wall closer to the front wall than the rear wall, or also in the center of a side wall.

1. Emergency exit door of an elevator car, in which elevator car the emergency exit door is hinged to at least one wall of the elevator car, wherein the emergency exit door is hinged to a wall of the elevator car to turn around two essentially vertical hinge lines.

2. Emergency exit door of an elevator car according to claim 1, wherein the emergency exit door is hinged to a wall of the elevator car to turn essentially simultaneously around two essentially vertical hinge lines.

3. Emergency exit door of an elevator car according to claim 1, wherein the emergency exit door comprises a support means, the first end of which is hinged with hinges to a wall of the elevator car and to the second end of which support means a door panel of the emergency exit door is hinged by means of hinges.

4. Emergency exit door of an elevator car according to claim 1, wherein the hinges of the first end of the support means are fitted to form a first hinge line and the hinges of the second end of the support means are fitted to form a second hinge line at the point of its hinge pins.

5. Emergency exit door of an elevator car according to claim 1, wherein the support means is fitted to turn around its hinge line in an opposite rotation direction to the door panel around its own hinge line.

6. Emergency exit door of an elevator car according to claim 1, wherein the edges of the door panel and the surface facing towards the inside of the elevator car are fitted to function as a part of the interior decoration of the elevator car.

7. Emergency exit door of an elevator car according to claim 1, wherein an interior decoration panel that is greater in its width and/or in its height than the door panel, and suited to the other interior decoration of the elevator car, is fixed on top of the door panel.

8. Emergency exit door of an elevator car according to claim 1, wherein the positioning, in the width direction of the emergency exit door panel, of the hinge pins of the hinges on the door panel is selected to be such that the ratio of the distance from the first edge of the door panel to the center line of the hinge pins to the distance from the second edge of the door panel to the center line of the hinge pins is approx. between 1.2 . . . 1.8; preferably between 1.4 . . . 1.6 and suitably approx. 1.5.
